(19) United States
(12) Patent Application Publication
(10) Pub. No.: US 2014/0376270 A1
(43) Pub. Date: Dec. 25, 2014

(54) POWER CONVERTERS INCLUDING LLC CONVERTERS AND METHODS OF CONTROLLING THE SAME

(71) Applicant: SunEdison LLC, Beltsville, MD (US)

(72) Inventors: Gregory Allen Kern, Fraser, CO (US); Timothy J. Condon, Foster City, CA (US)

(21) Appl. No.: 14/310,624

(22) Filed: Jun. 20, 2014

Related U.S. Application Data
(60) Provisional application No. 61/837,478, filed on Jun. 20, 2013.

(51) Int. Cl. H02M 3/335

(52) U.S. Cl. CPC H02M 3/33507
USPC 363/17

(57) ABSTRACT

Photovoltaic (PV) power converters including an LLC converter stage are described. A PV power converter includes a LLC converter stage and a controller. The LLC converter stage includes an input for receiving a direct current (DC) power input from a PV module, a first transformer having a primary winding and a secondary winding and defining a DC side and an alternating current (AC) side of the PV power converter, a plurality of switches on the DC side of the first transformer, and an output coupled to the secondary winding of the first transformer to provide a DC power output. The plurality of switches is coupled between the primary winding of the first transformer and the input. The controller is located on the AC side of the PV power converter. The controller is operatively connected to the plurality of switches and configured to control operation of the plurality of switches.

### CROSS REFERENCE TO RELATED APPLICATIONS

This application claims priority to U.S. Patent Application Ser. No. 61/837,478, filed Jun. 20, 2013, which is hereby incorporated by reference in its entirety.

### FIELD

This disclosure generally relates to power converters and, more specifically, to power converters including LLC converters and methods of controlling the same.

### BACKGROUND

In some known solar power systems, a plurality of photovoltaic (PV) panels (also known as solar panels) are logically or physically grouped together to form an array of solar panels. The solar panel array converts solar energy into electrical energy. The electrical energy may be used directly, converted for local use, and/or converted and transmitted to an electrical grid or another destination.

Solar panels generally output direct current (DC) electrical power. To properly couple such solar panels to an electrical grid, or otherwise provide alternating current (AC) power, the electrical power received from the solar panels is converted from DC to AC power. At least some known solar power systems use a single stage or a two-stage power converter to convert DC power to AC power. Some such systems are controlled by a control system to maximize the power received from the solar panels and to convert the received DC power into AC power that complies with utility grid requirements.

However, at least some known solar power converters are relatively inefficient, unreliable, and or expensive. Accordingly, a better solution is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

One aspect of the present disclosure is a photovoltaic (PV) power converter including a LLC converter stage and a controller. The LLC converter stage includes an input for receiving a direct current (DC) power input from a PV module, a first transformer having a primary winding and a secondary winding and defining a DC side and an alternating current (AC) side of the PV power converter, a plurality of switches on the DC side of the first transformer, and an output coupled to the secondary winding of the first transformer to provide a DC power output. The plurality of switches is coupled between the primary winding of the first transformer and the input. The controller is located on the AC side of the PV power converter. The controller is operatively connected to the plurality of switches and configured to control operation of the plurality of switches.

Another aspect of the present disclosure is a photovoltaic (PV) power converter including an LLC converter stage and a controller. The LLC converter stage includes an input for receiving a direct current (DC) voltage input from a PV module, a first transformer having a primary winding and a secondary winding, a plurality of switches coupled between the primary winding of the first transformer and the input, and an output coupled to the secondary winding of the first transformer to provide a DC power output. The controller is operatively connected to the plurality of switches. The controller is configured to control operation of the plurality of switches to generate the DC power output and to control a magnitude of the DC voltage input from the PV module.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic block diagram of an example power conversion system.

FIG. 2A is a schematic diagram of an example converter and controller for use in the system shown in FIG. 1.

FIG. 2B is a schematic diagram of another example converter and controller for use in the system shown in FIG. 1.

FIG. 3 is a timing diagram of the controller output signals driving the power switch states of the schematic shown in FIG. 2A.

FIG. 4 is an oscilloscope image showing timing of the controller output signals and gate voltages driving the power switch states of the schematic shown in FIG. 2A while operating at 1.2 Watts.

FIG. 5 is an oscilloscope image showing timing of the controller output signals and gate voltages driving the power switch states of the schematic shown in FIG. 2A while operating at 4.9 Watts.

FIG. 6 is an oscilloscope image showing timing of the controller output signals and gate voltages driving the power switch states of the schematic shown in FIG. 2A while operating at 28 Watts.

FIG. 7 is an oscilloscope image showing timing of the controller output signals and gate voltages driving the power switch states of the schematic shown in FIG. 2A while operating at 270 Watts.

FIG. 8 is a graph of control variables for the system shown in FIG. 2A.

Like reference symbols in the various drawings indicate like elements.

### DETAILED DESCRIPTION

The embodiments described herein generally relate to power systems. More specifically embodiments described herein relate to power converters including an LLC converter. Moreover, some embodiments described herein relate to LLC power converters for use with a photovoltaic power source and methods of controlling the same.

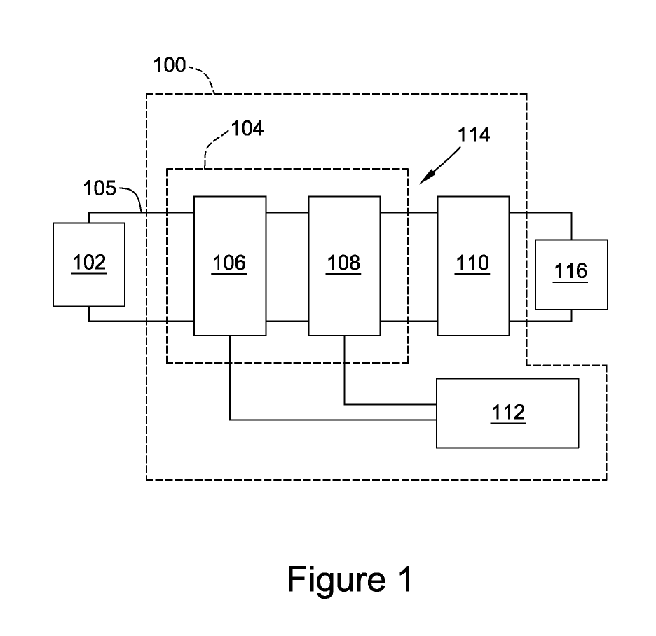

FIG. 1 is a schematic block diagram of an exemplary power conversion system 100. A power source 102 is coupled to power conversion system 100 to supply electrical current to system 100. In an exemplary embodiment, power source 102 is a photovoltaic (PV), or “solar”, module. Alternatively or additionally, power source 102 includes more than one PV module, at least one fuel cell, a direct current (DC) generator, and/or any other electric power source that enables power conversion system 100 to function as described herein.

In an exemplary embodiment, power conversion system 100 includes a power converter 104 to convert DC power received from power source 102 to an alternating current (AC) output. In other embodiments, power converter 104 may output DC power. The exemplary power converter 104 is a two stage power converter including a first stage 106 and a second stage 108. First stage 106 is a DC to DC power converter that receives a DC power input from power source 102 and outputs DC power to second stage 108. Second stage 108 is a DC to AC power converter (sometimes referred to as an inverter) that converts DC power received from first stage 106 to an AC power output. In other embodiments, power converter 104 may include more or fewer stages.

Power conversion system 100 also includes a filter 110, and a control system 112 that controls the operation of first stage 106 and second stage 108. Control system 112 is sometimes referred to herein as a controller. Control system 112 may include any suitable combination of analog components, digital components, integrated circuits, and/or discrete components suitable for operation as described herein. An output 114 of power conversion system 100 is coupled to filter 110. In an exemplary embodiment, filter 110 is coupled to an electrical distribution network 116, such as a power grid of a utility company. Accordingly, power conversion system 100 may be referred to as a grid tied inverter. In other embodiments, power converter 104 may be coupled to any other suitable load.

During operation, power source 102 generates a substantially direct current (DC), and a DC voltage is generated across input 105. The DC voltage and current are supplied to power converter 104. In an exemplary embodiment, control system 112 controls first stage 106 to convert the DC voltage and current to a substantially rectified DC voltage and current. The DC voltage and current output by first stage 106 may have different characteristics than the DC voltage and current received by first stage 106. For example, the magnitude of the voltage and/or current may be different. Moreover, in the exemplary embodiment, first stage 106 is an isolated converter, which operates, among other things, to isolate power source 102 from the remainder of power conversion system 100 and electrical distribution network 116. The DC voltage and current output by first stage 106 are input to second stage 108. Control system 112 controls second stage 108 to produce AC voltage and current, and to adjust a frequency, a phase, an amplitude, and/or any other characteristic of the AC voltage and/or current to match the electrical distribution network 116 characteristics. The adjusted AC voltage and/or current are transmitted to filter 110 for removing one or more undesired characteristics from the AC voltage and/or current, such as undesired frequency components and/or undesired voltage and/or current ripples. The filtered AC voltage and/or current are then supplied to electrical distribution network 116.

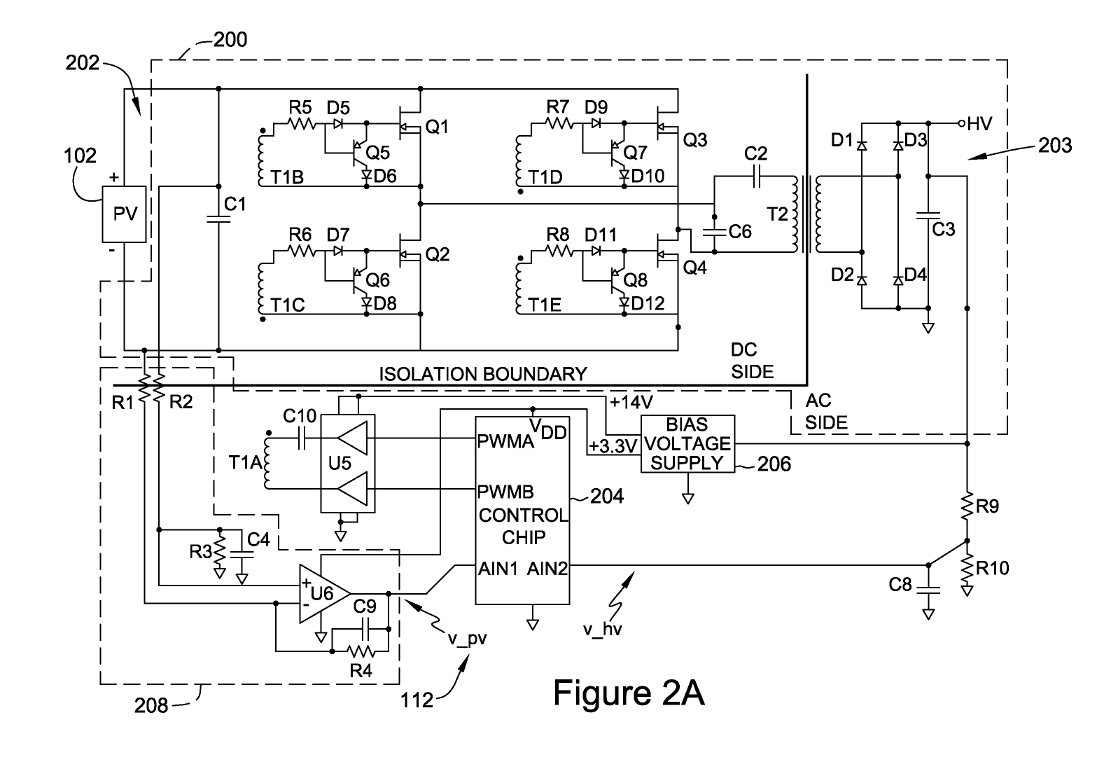

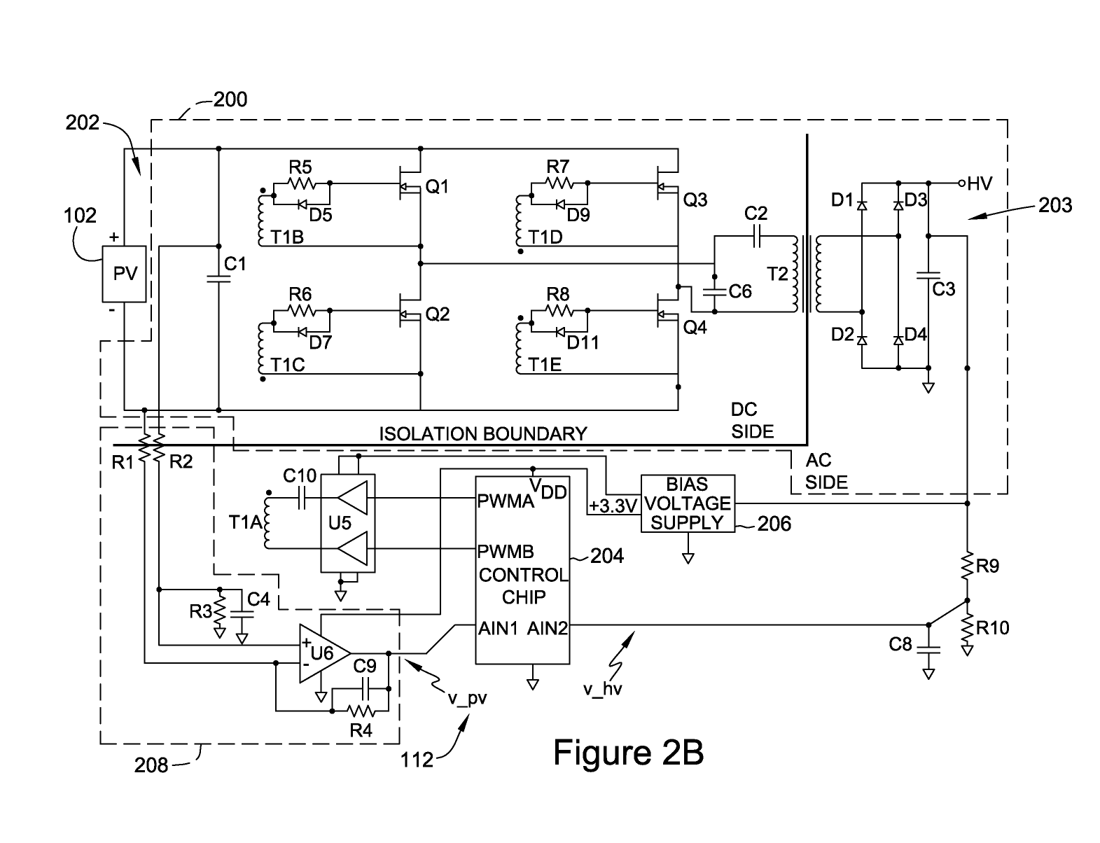

FIG. 2A is a schematic diagram of an example DC/DC converter 200 for use in first stage 106 and a portion of the control system 112 relevant to control of the DC/DC converter 200. The DC/DC converter 200 is an LLC DC/DC converter. In this example, power source 102 is a PV module. The output of the PV module 102 is connected to an input 202 of the DC/DC converter 200. The output of the converter 200 is a high voltage bus located at capacitor C3, which is connected to second stage 108 (not shown in FIG. 2A). In one example, PV module 102 is a 60 cell 270 Watt DC PV module that provides an output power between 0 and 270 Watts at 0 to 48 Volts, and is nominally operated at 22 to 36 Volts.

Capacitor C1 is an input filter with a capacitance of 52.8 uF. Capacitor C1 may be a single capacitor or a combination of multiple capacitors. In one embodiment, capacitor C1 includes 16 multi-layer ceramic capacitors (MLCC) connected in parallel. Each capacitor of the capacitor C1 rated at 3.3 uF and 100V. Capacitor C1 is used to filter switching currents of the DC/DC converter 200 to prevent them from affecting the input from the PV module 102.

Switches Q1, Q2, Q3, and Q4 are the main power switches for the DC/DC converter 200 and are arranged to form an H-bridge. Switches Q1, Q2, Q3, and Q4 are MOSFETs rated for 60V with an on resistance of 3.9 milliohms. Other MOSFETs with higher and lower on resistance and gate drive requirements may be used depending upon the efficiency and cost needs of the application. In one embodiment, switches Q1, Q2, Q3, and Q4 are BSC039N06NS MOSFETs from Infineon Technologies AG of Munich, Germany.

The gate drive circuit for each switch Q1, Q2, Q3, and Q4 includes a transistor, a resistor, and two diodes. As will be described in more detail below, the gate drive circuits receive control signals from the controller 112 and control switches Q1, Q2, Q3, and Q4 according to the received signals. Transistors Q5, Q6, Q7, and Q8 are PNP bipolar transistors rated for 2 amps at 40 volts. One example transistor suitable for use as transistors Q5, Q6, Q7, and Q8 is part no DSS5240T available from Diodes Inc. of Plano, Tex. Diodes D5, D6, D7, D8, D9, D10, D11, and D12 are small signal silicon diodes capable of operating at gate drive current levels. One suitable diode is part number 1N4448X available from Micro Commercial of Chatsworth, Calif. Resistors R5, R6, R7, and R8 are used in the gate drive circuit control how fast the switches Q1, Q2, Q3, and Q4 turn on and turn off. In one example embodiment, the resistors R5, R6, R7, and R8 have a value of 50 Ohms.

Capacitor C2 is the series resonant capacitor of the converter 200 (i.e., the “C” in “LLC”). Capacitor C2 consists of three 0.47 uF capacitors in parallel, each rated for pulsed current application. In some embodiments, the capacitors for C2 are 250MPH474K film capacitors available from Rubycon Corporation of Nagano, Japan. Alternatively, the capacitor C2 may be a single capacitor or a different number of capacitors.

Capacitor C6 is an optional capacitor. The capacitor C6 slows down the switching edges and aids in maintaining zero voltage switching of switches Q1, Q2, Q3, and Q4. In one example, C6 includes two capacitors each with a capacitance of 0.022 uF for a total of 0.044 uF. Each capacitor is rated for pulse applications. One suitable capacitor is part B32621A6223J available from EPCOS AG of Munich, Germany.

Transformer T2 has a specified magnetizing inductance and a specified leakage inductance, which are the two “L”s in “LLC”. Transformer T2 has one primary winding with four turns of No. 12 AWG insulated Litz wire, and one secondary winding with 46 turns of three strands of No. 29 AWG magnet wire. The transformer has a magnetizing inductance of 10.8 uH and a leakage inductance of 1.5 uH, both with a tolerance of +/−20%. Leakage inductance is controlled by maintaining spacing between primary and secondary. The core of transformer T2 is a ferrite P type material shaped for use as a planar transformer. Dimensions of the overall core are 1.84 inches long, 1.15 inches wide, 0.80 inches high (approximately 4.674 centimeters long, 2.921 centimeters wide, and 2.032 centimeters high). The center leg of the core is 0.425 inches (approximately 1.080 centimeters) wide with a cross sectional area of 0.609 square inches (3.929 square centimeters). The window area of the core has an area of 0.10 square inches (approximately 0.645 square centimeters).

The output of the transformer T2 is rectified through diodes D1, D2, D3, and D4 into output capacitor C3, which is connected to the high voltage output 203 of the converter 106. Diodes D1, D2, D3, and D4 convert the AC output of transformer T2 into high voltage DC stored on C3. The converter 200 generally operates in a soft switching mode, permitting diodes D1, D2, D3, and D4 to be silicon based diodes. In one embodiment, diodes D1, D2, D3, and D4 are STTH5L06B diodes available from STMicroelectronics of Geneva, Switzerland.

Capacitor C3 is a filter and storage capacitor on the output of the converter 200. Capacitor C3 is constructed of two 12 uF capacitors in parallel, each rated at 575V.

Operation of the DC/DC converter 200 is controlled by the control system 112. The control system 112 is generally located on the AC side of transformer T2. In the example embodiment, transformer T1 is located on the AC and the DC sides of the converter 200, feedback resistors R1 and R2 cross the isolation barrier, and no components of the control system 112 are located solely on the DC side of transformer T2.

Control system 112 includes control chip 204. Control chip 204 is an integrated circuit. More particularly, the control chip 204 is a microcontroller. The illustrated control chip 204 is a TMS320F28027PT piccolo microcontroller available from Texas Instruments Incorporated of Dallas, Tex. Alternatively, any other suitable control chip may be used. The control chip 204 has two analog inputs AIN1 and AIN2 for feedback control of input and output voltage and has two control outputs PWMA and PWMB. The control chip is powered from a 3.3V supply.

Bias voltage supply 206 takes power from the output 203 and converts it to 14 volts and 3.3 volts for powering the control system 112. Alternatively, bias voltage supply may generate any other voltage(s) needed by the particular implementation of the control system 112. Moreover, bias voltage supply 206 may be any suitable type of power supply for converting power from the output 203 to the voltages used by the control system 112.

Resistors R1 and R2 are sense resistors used to provide input voltage feedback to control chip 204. Resistors R1 and R2 cross the isolation boundary between the input 202 and the output 203 of the converter 200. In one example, resistors R1 and R2 are 4.99 megaohm, ½ Watt resistors rated for high voltage application. Resistors R1 and R2 are connected to a voltage sense circuit 208. or three 1 Mohm Vishay CRCW25121M00FKEG resistors.

Voltage sense circuit 208 includes an operational amplifier U6. Operational amplifier U6 is an integrated circuit, low power, rail to rail operational amplifier. Operational amplifier U6 is powered by the 3.3 volt supply from bias voltage supply 206. One example operational amplifier suitable for use in the control system 112 is AD8601 available from Analog Devices, Inc. of Norwood, Mass.

Resistor R4 is a feedback resistor for operational amplifier U6 and has a resistance of 150 kohm. Capacitors C4 and C9 provide a low pass response to the operational amplifier U6. In one example, the capacitors C4 and C9 each have a capacitance of 47 pF. Resistor R3 is a bias resistor used to reference the operational amplifier U6 to control logic ground and has a resistance of 150 kiloohm.

Gate drive U5 provides a bipolar drive for gate drive transformer T1. Gate drive U5 is a dual low side, integrated circuit, gate drive chip. Gate drive chip U5 is powered by the 14V supply from bias voltage supply 206. One suitable gate drive chip is PM8834TR available from ST Microelectronics STMicroelectronics of Geneva, Switzerland.

Capacitor C10 blocks DC voltage from being applied to T1 to help prevent saturation of transformer T1 by gate drive U5. Capacitor C10 may be omitted from control system 112 if transformer T1 would not be saturated by gate drive chip U5. In the example embodiment, C10 is a 1.0 uF ceramic chip capacitor.

Transformer T1 is a gate drive transformer with one primary winding T1A and four secondary windings T1B, T1C, T1D, and T1E all wound on an EE13 ferrite core. The turns ratio from the primary winding T1A to each of the secondary windings is 1:0.714. This turns ratio is provided to operate at a substantially optimal efficiency. Higher or lower turns ratio may be used depending on the specific application. The primary inductance is 1.0 mH minimum, with a max leakage inductance of 5.5 uH. Isolation from the primary winding T1A to the secondary windings T1B, T1C, T1D, and T1E is rated at 2500V.

Resistor R9 is the upper half of a voltage divider used to sense the high voltage bus voltage on the output 203 of the converter 200. In the example embodiment, resistor R9 consists of one 4.99 Mohm resistor, 2512 size, surface mount resistors connected in series. Resistor R10 is the lower half of the voltage divider used to sense the high voltage bus voltage on the output 203 of the converter 200. In the example embodiment, R10 is a 28.0 kiloohm resistor. Capacitor C8 is used to give a low frequency pass feature to the resistor divider formed by resistors R9 and R10. In the example embodiment, capacitor C8 has a capacitance of 220 pF.

As described above, DC/DC converter is an LLC converter that receives a DC input from PV module 102 and outputs a DC output. In general, switches Q1, Q2, Q3, and Q4 are selectively switched to generate a square wave from the DC input from the PV module 102. The square wave excites the resonant tank formed by capacitor C2 and the magnetizing and leakage inductances of transformer T2. The current generated by the resonant tank is scaled by the transformer T2 according to the turns ratio of the transformer T2 and rectified by diodes D1, D2, D3, and D4.

FIG. 2B is a schematic diagram of another example DC/DC converter 250 for use in first stage 106 and a portion of the control system 112 relevant to control of the DC/DC converter 200. The converter 250 is similar to the converter 200 shown in FIG. 2A except as otherwise described and/or shown. Common components in FIGS. 2A and 2B are identified with common references identifiers. Converter 250 does not include the switches Q5, Q6, Q7, Q8 and diodes D6, D8, D10, and D12 that are included in converter 200. The diodes D5, D7, D9 and D11 are connected in converter 250 to discharge gate voltages. This simplification of the gate drive circuit is possible because of the soft switching operation of the circuit and the high gate drive 50 ohm impedance.

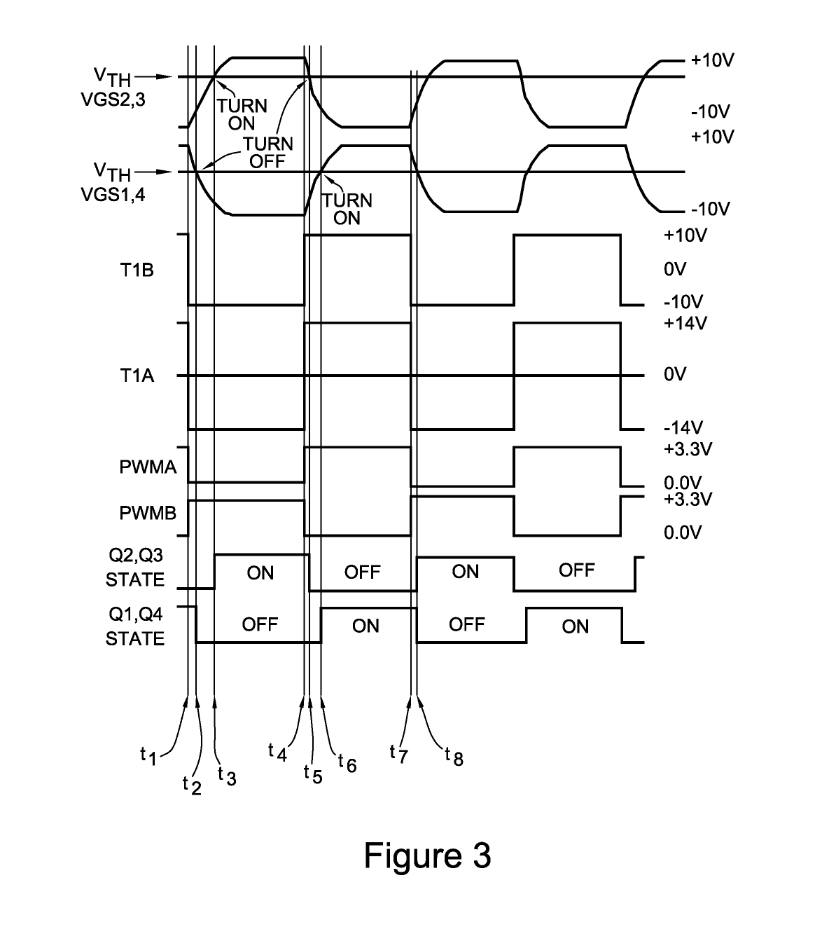

FIG. 3 is a graphical representation of the control system 112 output and the switch states of the switches Q1, Q2, Q3, and Q4. FIG. 3 is not drawn to scale.

Control system 112 can operate in different modes. One mode of operation for the controller 112 is the OFF mode, where DC to DC power conversion is turned off. In the OFF mode of operation, the two control outputs PWMA and PWMB of control chip 204 remain static (i.e., not changing state). Outputs PWMA and PWMB can both be high, both be low, or one of each, so long as they are not changing. During the OFF mode, capacitor C10 prevents saturation of the gate drive transformer T1. This mode of operation is not illustrated in FIG. 3.

The primary mode of operation of the control system 112 is to drive its two outputs PWMA and PWMB in a complementary mode where PWMB and PWMA are opposite. This is the mode used for the majority of time when converting power. PWMA and PWMB are digitally controlled by a PWM peripheral inside control chip 204. Frequency and duty cycle are two operating parameters that are controlled by firmware. As shown in FIG. 3, the duty cycle for signals PWMA and PWMB is fixed at 50%. The signals PWMA and PWMB have a value of 0.0 volts or 3.3 volts depending on the logic state of the signal (i.e. o volts for a logical zero/low and 3.3 volts for a logical one/high). The output signals PWMA and PWMB are output to the gate drive U5.

The gate drive U5 provides level shift and drive capability to charge and discharge the gates of the switches Q1, Q2, Q3, and Q4 through the gate drive transformer T1. The gate drive U5 is powered by the 14 volt bus from bias voltage supply 206 and its outputs operate from 0 to 14V depending upon the state of its two input signals (i.e., PWMA and PWMB). The voltage applied to the primary of transformer T1 is seen in the timing diagram as T1A. In this mode of operation, T1A operates at +14V and −14V because of the bipolar drive circuit configuration and level shifting of gate drive U5. In some embodiments, gate drive U5 may be omitted if control chip 204 has sufficient drive capability to drive the primary of the gate drive transformer at 3.3V, preferably using a bipolar drive circuit configuration. In an embodiment without gate drive U5, the turns ratio of the transformer T1 would be adjusted to a value of 1:3:3:3:3, with the primary operating at +/−3.3V and the secondaries operating at +/−10V. In yet another possible embodiment, it would be possible to eliminate capacitor C10 if the control chip 204 could be programmed so that PWMA and PWMB outputs do not output a DC voltage under any operating conditions, including reset of the control chip 204.

The secondaries of the transformer T1 produce waveforms similar to the primary T1A. One of the secondaries (specifically, T1B) is shown in FIG. 3. Secondary T1B is in phase with the primary T1A, but operates at +/−10V due to the step down turns ratio of 1:0.714. Driving the gates at +/−10V provides reliable gate switching, but is not so high a voltage as to cause excessive gate drive losses. Secondary winding T1E will produce a waveform substantially the same as secondary winding T1B, while secondary windings T1C and T1D produce waveforms that are 180 degrees out of phase with the waveform of T1B.

Gate drive signals for switches Q1 and Q4 are shown on the trace VGS1,4. The gate drive signals for Q1 and Q4 are the same because they are driven by gate drive secondaries T1B and T1E that have the same polarity. Gate drive signals for switches Q2 and Q3 are shown on trace VGS2,3. The gate drive signals for Q2 and Q3 are the same because they are driven by gate drive secondaries T1C and T1D that have the same polarity.

With reference to the gate drive signals VGS1,4 and VGS2,3, there is a threshold voltage Vth at which the gate of each switch Q1, Q2, Q3, and Q4 has reached the charge that causes the switch to turn on or off. When the gate to source voltage (i.e., VGS) exceeds the threshold Vth, the switch turns on. Below the threshold Vth, the switch Q1, Q2, Q3, or Q4 is off. In the example embodiment, the gate threshold voltage is typically 2.8 volts.

Timing of one cycle of operation of the converter 200 will be described with reference to times t1 to t7. At time t1, signal PWMA and the voltages on windings T1A and T1B switch from hi to low. Also at time t1, the gate voltages on switches Q2 and Q3 start to rise from −10V due to charging through the resistor and diode coupled to the gate of each switch Q2 and Q3 (i.e., R6 and D7, R7 and D9). The gate voltages on Q1 and Q4 start to fall from +10V due to discharging through transistors Q5 and Q7 and diodes D6 and D10. The gate voltage discharge rate is much faster than the charge rate when the gate voltage being discharged is above two diode drops or approximately 1.4 volts. At time t2, the gate voltage on switches Q1 and Q4 has dropped to the threshold voltage Vth and switches Q1 and Q4 turn off as shown in Q1,Q4STATE. At time t3, the gate voltage on switches Q2 and Q3 has risen to the threshold voltage Vth and switches Q2, Q3 turn on as shown in Q2,Q3STATE.

At time t4, signal PWMA and the voltage on windings T1A and T1B rises and the gate voltage on switches Q1 and Q4 starts to rise. Also at time t4, the gate voltage on switches Q2 and Q3 starts to fall, being discharged through Q6, D8 and Q7, D10 respectively. At time t5, the gate voltage on switches Q2 and Q3 have fallen to the threshold voltage, Vth, and switches Q2 and Q3 turn off. At time t6, the gate voltage on switches Q1 and Q4 have risen to the threshold voltage, Vth, and the switches Q1 and Q4 turn on. At time t7, the cycle described above starts over again.

The period of the switching cycle is defined as

P=t7−t1 (1)

and the frequency is the reciprocal of the period. The on time of switches Q1 and Q4 is

O1=t8−t6 (2)

and the on time of switches Q2 and Q3 is

O2=t5−t3 (3)

The duty cycle D for each switch Q1, Q2, Q3, or Q4 is the on time of that switch relative to the total on time for each switching cycle. The duty cycle for switches Q1 and Q4 is

D=O1/(O1+O2) (4)

Due to the symmetry of the drive signals, the on time of switches Q1 and Q4 equals the on time of switches Q2 and Q3. Thus, the converter 200 always operates with a fixed duty cycle of 50%. The dead time (i.e., when all switches Q1, Q2, Q3, and Q4 are off) is

DT=t3−t2=t6−t5 (5)

The dead time DT of both switch transitions are equal due to the symmetric nature of the drive circuit and operation. The dead time DT is controlled by the resistance of the resistors R5, R6, R7, and R8 and by the effective capacitance of the gate charge of switches Q1, Q2, Q3, and Q4. Dead time DT may be increased by increasing the resistance and decreased by decreasing the resistance. The drain to source voltages of switches Q1, Q2, Q3, and Q4 commutate, thereby allowing zero voltage switching, during the dead time DT. This zero voltage switching is aided by the use of C6 which provides a slower, more controlled dv/dt during DT.

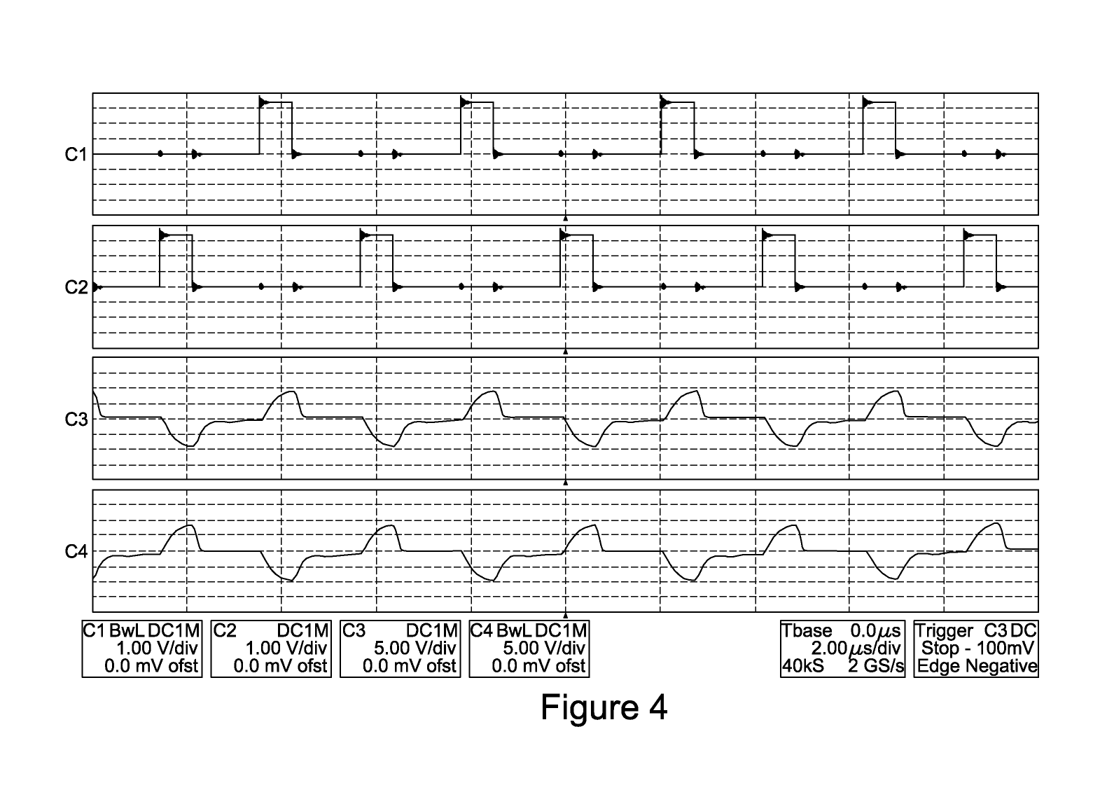

FIG. 4 is an oscilloscope capture of the control output signals and the gate voltages of two of the switches Q1, Q2, Q3, and Q4 when the converter 200 is operating at 1.2 watts. The top trace C1 is signal PWMA and the second trace C2 is signal PWMB. The third trace C3 is signal VGS4 and the fourth trace C4 is signal VGS2. In order for the converter 200 to operate at very low power, the dead time between the control output pulses becomes very large relative to the pulses themselves. In this figure, the converter 200 is operating at a frequency of 238 kHz. The duty cycle is still 50%. As power approaches zero, the dead time increases until the on time approaches zero as well. This mode of operation is not illustrated in FIG. 3.

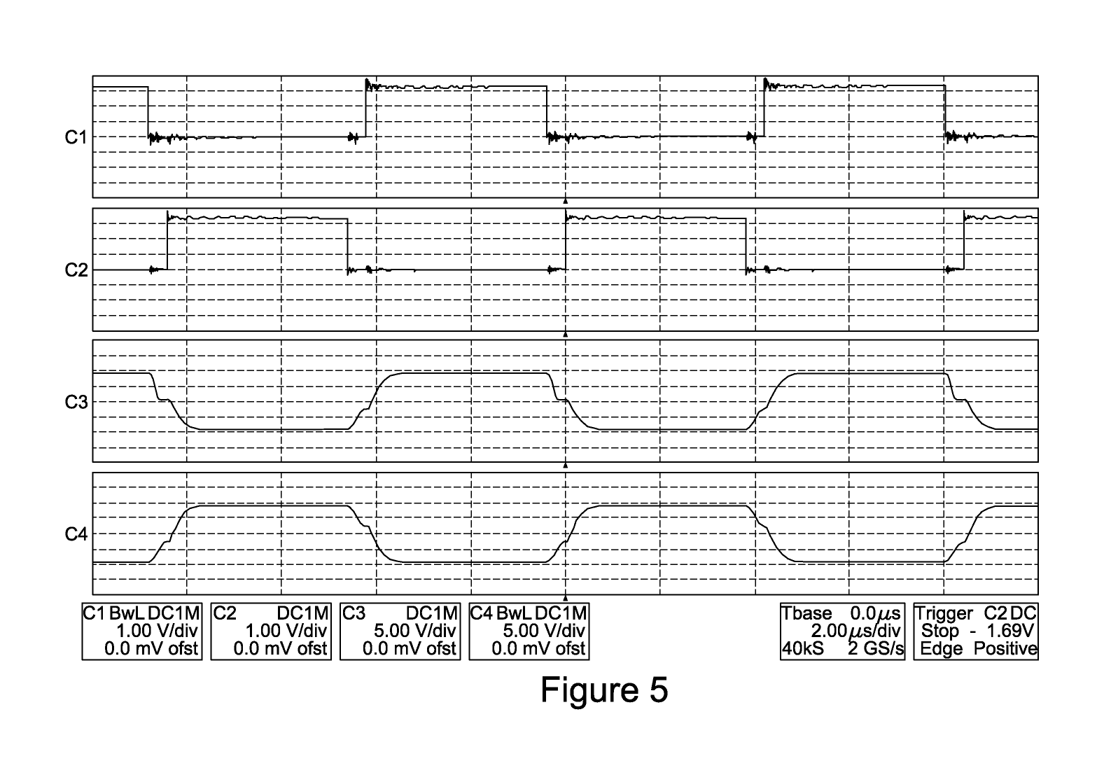

FIG. 5 is an oscilloscope capture of the control output signals and the gate voltages of two of the switches Q1, Q2, Q3, and Q4 when the converter 200 is operating at 120 kHz and 4.9 watts. The traces C1-C4 correlate to the same signals shown in FIG. 4. Dead time has almost reached its minimum and duty cycle is still 50%.

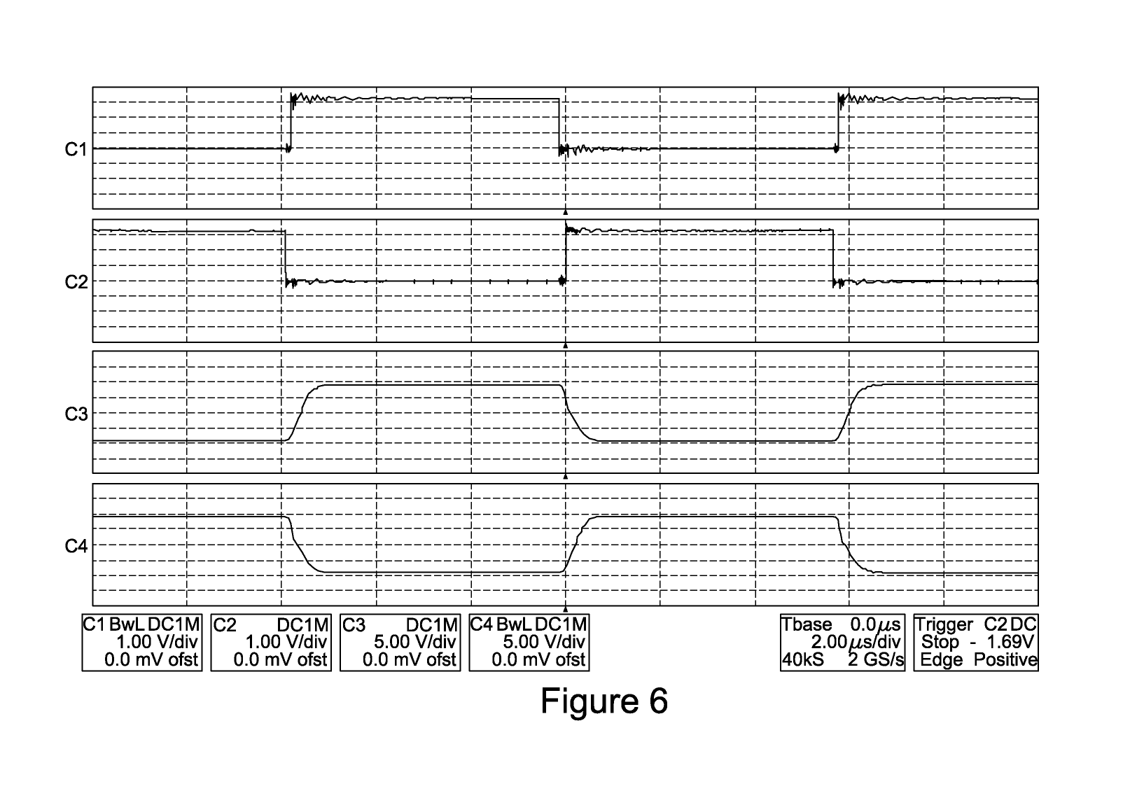

FIG. 6 is an oscilloscope capture of the control output signals and the gate voltages of two of the switches Q1, Q2, Q3, and Q4 when the converter 200 is operating at 86 kHz and 28 watts. The traces C1-C4 correlate to the same signals shown in FIG. 4. Dead time is at its minimum and duty cycle is still 50%.

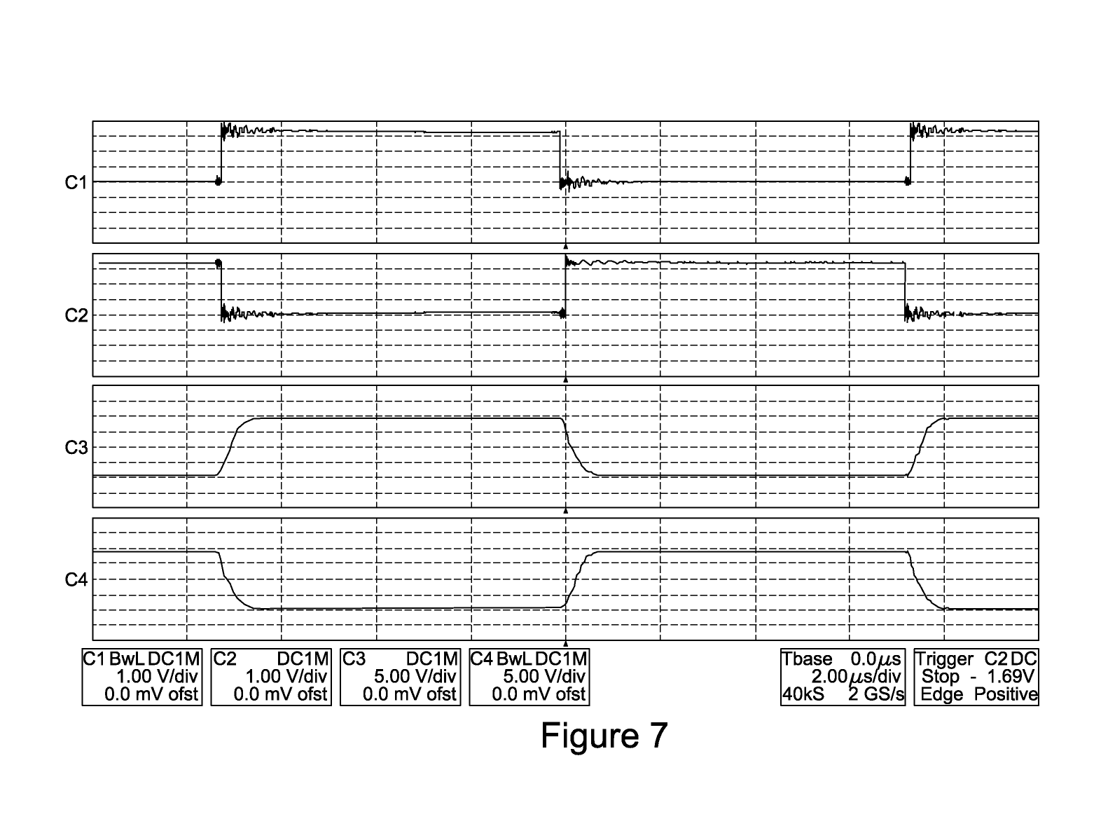

FIG. 7 is an oscilloscope capture of the control output signals and the gate voltages of two of the switches Q1, Q2, Q3, and Q4 when the converter 200 is operating at 69 kHz and 270 watts. The traces C1-C4 correlate to the same signals shown in FIG. 4. Dead time is at its minimum and duty cycle is still 50%.

Operation of the DC/DC converter 200 will be described in more detail with reference to FIG. 2A. In this example, the converter 200 is configured for use with a sixty cell, 270 watt PV module input. During operation of the DC/DC converter 200, switches Q1, Q2, Q3, and Q4 are driven or controlled by gate drive transformer T1. The polarity of the secondary windings T1B, T1C, T1D, and T1E of the transformer T1 determines which switches are on and off at any given time. Secondary windings T1B and T1E have the same polarity, thereby driving switches Q1 and Q4 on and off at the same time. Switches Q2 and Q3 are coupled to windings T1C and T1D, which have the same polarity, and are driven on and off at the same time. Switches Q1 and Q4 are driven with opposite polarity to switches Q2 and Q3. This, in combination with the fact that the turn on time of switches Q1, Q2, Q3, and Q4 is slower than the turn off time, ensures that no two switches in the same leg of the H-bridge are on at the same time, thus avoiding shoot thru failure of the H-bridge.

Two feedback signals are provided to the control chip 204. The first feedback signal is a PV input voltage signal v_pv. Signal v_pv is sensed across the isolation barrier using the high impedance sense resistors R1 and R2. The sense resistors R1 and R2 are coupled to the voltage sense circuit 208, which is a differential amplifier circuit using operational amplifier U6. This differential amplifier circuit has good common mode rejection and amplifies the difference between the two inputs. In the example embodiment, the gain is less than unity, and the voltage sense circuit scales the voltage difference down for input into an analog to digital (a/d) converter inside control chip 204. The gain of the differential amplifier circuit is about 0.060. A gain of 0.060 scales a 54.7V PV input voltage down to about 3.30 volts at the input to the a/d converter input AIN1. The second feedback signal provided to control chip 204 is v_hv, which represents the high voltage output of the converter 200. The signal v_hv is provided by the resistor divider defined by the resistors R9 and R10 with a gain of 0.0056. A gain of 0.0056 scales the high voltage at the output 203 down from about 590 volts to about 3.30 volts, which can be sampled by a/d converter input AIN2.

The two feedback signals are used to control operation of the DC/DC converter 200. Signal v_hv is used in part to prevent over voltage on the output 203 of the converter 200. One way of doing this is with a simple hysteretic type control such as:

If (v_{—}hv>525 Volts) then turn DC OFF (6)

and

If (v_{—}hv<500 Volts) then turn DC ON (7)

The signal v_hv can be used to control the converter 200 using proportional feedback so that the high voltage bus voltage is controlled when the output load suddenly drops or excessive power is suddenly applied to the input 202 of the converter 200. As described above, the converter 200 operates at a fixed duty cycle and the converter is controlled by varying the switching frequency (or the period of the switching cycle) of the switches Q1, Q2, Q3, and Q4. The maximum period is defined as

period_max=1/freq_min (8)

and the minimum period is defined as

period_min=1/freq_max (9)

where freq_min is a defined minimum frequency and freq_max is a defined maximum frequency. The least power is delivered at the maximum frequency and the greatest power is delivered at the minimum frequency. In the example embodiment, the minimum frequency is set at 50,000 Hz and the maximum frequency is 300,000 Hz. An error value is determined by

error1=v_{—}hv−v_{—}hv_target (10)

where v_hv_target is a defined target output voltage for the converter 200. In the example embodiment, v_hv_target is 500 volts. The period for the switching cycle is calculated from

period1=Kp1*error1 (11)

where Kp1 is a defined proportional gain. However, if period1 in equation (11) is greater than period_max determined in equation (8), period1 is set equal to period_max. If period1 is less than period_min found by equation (9), period1 is set equal to period_min.

The target output voltage v_vh_target is the ideal control target voltage for Vhv. However, it is understood in proportional control that you can never drive to zero error. The target v_hv_target in combination with the proportional gain Kp1 defines the range of high voltage over which the control signal period1 will be affected. In the example embodiment, the period, rather than the frequency, is controlled in the firmware of the controller 204, and there is no actual need to compute frequency, and the control limits in equations (8)-(11) define the range of frequency operation between 50 kHz and 300 kHz.

Control system 112 operates the converter 200 to control the voltage output from the PV panel 102. The goal is to regulate the input voltage from the PV module 102 to substantially minimize or eliminate ripple on the voltage output from the PV module 102 and input to the converter 200. The two stage design of the power converter 104 permits limitation and/or elimination of voltage ripple from the PV module 102 output, thereby increasing the amount of energy that may be captured from the PV module 102. In single phase inverters, it is common for there to be some amount of ripple at twice the grid line frequency, which in the US would be 120 Hz. Anytime the PV voltage is not at its maximum power point voltage there is some lost energy that is not captured. This lost energy is not measured as a loss in the converter but is measured as energy that did not enter the converter in the first place. This is understood in the art of solar power inverters and is why some designs require very large capacitors at the PV input to the inverter to minimize the ripple voltage.

One or more control strategies may be implemented to control converter 200 to achieve fast regulation of the PV input voltage and limit magnitude of voltage ripple present on the input 202. In some embodiments, controller 112 uses integral control to control converter 200. A target output voltage v_pv_target for the PV module 102 is set by a maximum power point routine. If v_pv_target is greater than a predetermined maximum target value, v_pv_target is set equal to the maximum target value. If v_pv_target is less than a predetermined minimum target value, v_pv_target is set equal to the minimum target value. In the example embodiment, the maximum target value is 36 volts and the minimum target value is 22 volts. An error value is calculated by

error2=v_{—}pv−v_{—}pv_target (12)

where v_pv is the voltage input from the PV module 102. An increment value period_step, which is an amount by which to change the switching period (and thus the switching frequency), is determined based on the error value error2. If the value error2 is greater than 0, the increment value period_step is a positive predetermined amount of time. If the value error2 is less than 0, the increment value period_step is a negative predetermined amount of time. In the example embodiment, the positive increment is 83.3 ns and the negative increment is −83.3 ns. The length of the switching period is set as

period2=period2+period_step (13)

The switching period is limited by predetermined minimum and maximum periods. If period2 is greater than the predetermined maximum, period 2 is set equal to the maximum period. If period2 is less than the predetermined minimum, period 2 is set equal to the minimum period.

The integral control described above is operable to minimize the average error, and may advantageously drive the average error to zero or substantially zero. Some embodiments add a relatively small amount of proportional control to the integral control described above in order to reduce the amount of oscillation that occurs with integral control. Controller 112 calculates a switching period as

period3=Kp3*error2+period2 (14)

where Kp3 is the proportional gain constant. The two control parameters period1 and period3 are combined to operate the converter 200 at the shorter period, and hence the lower power, of the two control variables. Thus, the control system 112 sets the period of the PWMA and PWMB outputs equal to the lesser of period1 and period2.

As mentioned above with respect to FIGS. 4-7, the converter 200 includes a minimum dead time between switching of the switches Q1, Q2, Q3, and Q4. The minimum dead time is applied in firmware for the control of signals PWMA and PWMB. The dead time permits soft switching of the switches Q1, Q2, Q3, and Q4 by allowing time for the drain voltages to decrease to zero before the next switches Q1, Q2, Q3, and Q4 are turned on. The amount of dead time may be varied to achieve the desired soft switching operation of the converter 200.

In one example, values for the maximum switching frequency, the minimum dead time, the nominal frequency, and the minimum switching frequency are defined. The maximum frequency is 300 kHz, the minimum dead time is 833 nanoseconds, the nominal frequency is 100 kHz, and the minimum frequency is 50 kHz. The clock frequency of the controller 112 is 24 MHz. The minimum switching period, the nominal switching period, the minimum dead time, and the maximum switching period variables are calculated and defined. The minimum PWM switching period is an integer that is half of the clock frequency divided by the maximum frequency. The nominal switching period is an integer that is half of the clock frequency divided by the nominal frequency. The minimum dead time is an integer that is half of the clock frequency divided by the dead time frequency. The maximum PWM switching period is an integer that is one half the clock frequency divided by the minimum frequency.

The DC control signal (dc_control), which is the desired operating point determined by the controller 112, is constrained between the determined maximum PWM switching period and the minimum PWM switching period. If the DC control signal exceeds the maximum switching period, it is set equal to the maximum switching period. If the DC control signal is less than the minimum switching period, it is set equal to the minimum switching period.

The dead time when all switches Q1-Q4 are switched off (dc_deadband) is computed based on the DC control signal. Specifically, the dead time is calculated by subtracting the DC control value from the calculated dead time period. The dead time is constrained between a minimum and a maximum dead time. The minimum is a preset minimum dead time, which in this example has a value of six clock cycles (or counts). The maximum deadband is determined as a function of the DC control signal. In this example, the maximum dead time is about twice the value of the DC control signal. If the calculated dead time exceeds the maximum, it is set equal to the maximum. If the calculated dead time is less than the minimum, it is set equal to the minimum. Between the minimum and maximum dead times, the calculated dead time is not changed. The control variables are then written to hardware registers for use in operating the converter 200.

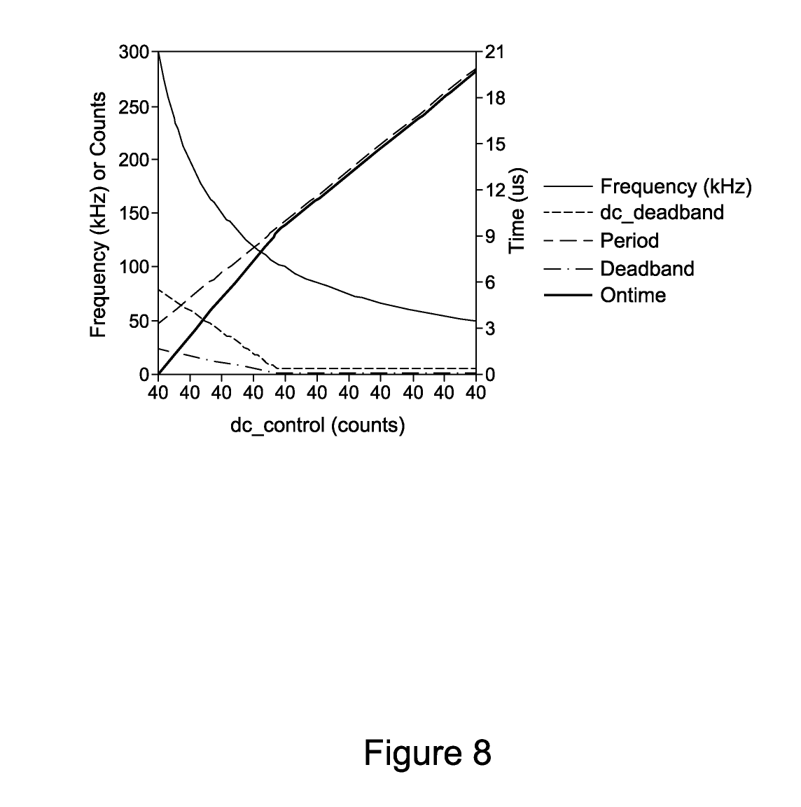

FIG. 8 is a graph of the control signals of the converter 200 as a function of the dc_control signal. As the dc_control signal varies from 40 counts (i.e., clock cycles), the switching frequency decreases from 300 kHz to 50 kHz. The ontime is the time that the signals PWMA and PWMB are hi, and therefore the time in one period that the switches Q1-Q4 are conducting. When the dc_control signal is 40 and the switching frequency is 300 kHz, the ontime is zero. As the dc_control increases from 40 to about 113, the dead band time decreases from its maximum to a minimum time and the difference between the ontime and the period decreases to its minimum. The difference between the ontime and the period above a dc_control of 113 is the minimum dead time. In the exemplary embodiment, the minimum is 6 counts, which equals 0.125 microseconds at the exemplary clock speed of 24 MHz.

Power conversion systems including LLC converters as described herein may achieve superior results to known methods and systems. The power conversion systems described herein provide a low parts count and low cost solution for the control circuits and methods for operating an LLC DC/DC power converter. The example systems use a single control chip to operate the first and second stage of the power conversion system. A separate control chip is not used to control the LLC converter, and there are no controllers on the DC side of the conversion system. Moreover, the controller in some embodiments is configured to control the LLC converter to control the input voltage from the PV module. By tightly controlling the input voltage at about the maximum power point of the PV module and limiting the amount of voltage ripple, more power may be extracted from the PV module. The described power conversion systems thus provide a low cost, high quality, high reliability solar power conversion system

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A photovoltaic (PV) power converter comprising:
an LLC converter stage comprising:
an input for receiving a direct current (DC) power input from a PV module;
a transformer having a primary input winding and a secondary output winding defining a primary side and an output side of the PV power converter;
a plurality of switches on the primary side of the converter, the plurality of switches coupled between the primary winding of the transformer and the input; and
an output coupled to the secondary winding of the transformer through a plurality of diodes to provide a DC power output; and
a controller located on the output side of the PV power converter, the controller operatively connected to the plurality of switches and configured to control operation of the plurality of switches.

2. The PV power converter of claim 1, further comprising an inverter stage coupled to the output of the LLC converter stage.

3. The PV power converter of claim 2, wherein the controller is operatively connected to the inverter stage and further configured to control operation of the inverter stage.

4. The PV power converter of claim 1, further comprising a second transformer, and wherein the controller is operatively coupled to the plurality of switches through the second transformer.

5. The PV power converter of claim 4, wherein the second transformer comprises a primary winding and a plurality of secondary windings, and wherein the controller is coupled to the second transformer primary winding and the plurality of secondary windings are coupled to the plurality of switches.

6. The PV power converter of claim 5, wherein a first half of the plurality of secondary windings have a first polarity, and a second half of the plurality of secondary windings have a second polarity different from the first polarity.

7. The PV power converter of claim 6, wherein a first half of the plurality of switches are coupled to the first half of the plurality of secondary windings, and a second half of the plurality of switches are coupled to the second half of the plurality of secondary windings.

8. The PV power converter of claim 5, wherein each switch of the plurality of switches is coupled to a different secondary winding of the plurality of secondary windings.

9. The PV power converter of claim 1, wherein the controller is configured to switch the plurality of switches at a fixed duty cycle and a variable switching period based at least in part on the power input from the PV module and the power output.

10. A photovoltaic (PV) power converter comprising:
a LLC converter stage comprising:
an input for receiving a direct current (DC) voltage input from a PV module;
a transformer having a primary winding and a secondary winding;
a plurality of switches coupled between the primary winding of the transformer and the input; and
an output coupled to the secondary winding of the transformer through a plurality of diodes to provide a DC power output; and
a controller operatively connected to the plurality of switches and configured to control operation of the plurality of switches to generate the DC power output and to control a magnitude of the DC voltage input from the PV module.

11. The PV power converter of claim 10, wherein the controller is configured to control the magnitude of the DC voltage input from the PV module by varying a switching period of the plurality of switches.

12. The PV power converter of claim 11, wherein the controller is configured to increase a length of the switching period when the DC voltage input exceeds a target input voltage.

13. The power converter of claim 12, wherein the controller is configured to decrease the length of the switching period when the DC voltage input is less than the target input voltage.

14. The power converter of claim 13, wherein the controller is configured to determine the target input voltage.

15. The power converter of claim 14, wherein the controller is configured to determine the target input voltage based on a maximum power point algorithm.

16. The power converter of claim 11, wherein the controller is configured to vary the switching period between a predetermined minimum value and a predetermined maximum value.

17. The power converter of claim 16, wherein the predetermined minimum value corresponds to a switching frequency of 300 kilohertz and the maximum value corresponds to a switching frequency of 50 kilohertz.

18. The power converter of claim 10, wherein the controller is configured to control the plurality of switches with a fixed duty cycle.

19. The power converter of claim 18, wherein the fixed duty cycle is fifty percent.

20. The power converter of claim 10, wherein the controller is configured to control the magnitude of the DC voltage input from the PV module using a combination of integral control and proportional control.

21. The power converter of claim 11, wherein the controller is configured to control dead time as a function of switching period to improve the ability to control DC voltage input.
